(19) United States
(12) Patent Application Publication
(10) Pub. No.: US 2009/0285689 A1
(43) Pub. Date: Nov. 19, 2009

(54) Vertical Axis Wind Turbine Having Angled Leading Edge

(76) Inventors: Ronald Hall, Woodstock (CA); John Bradley Ball, Lakeside (CA)

Correspondence Address: BRUNET & CO. LTD., 10712 MELROSE DR., KOMOKA, ON, N0L-1R0, CA

(21) Appl. No.: 12/465,644

(22) Filed: May 14, 2009

Related U.S. Application Data
(60) Provisional application No. 61/053,018, filed on May 14, 2008.

(51) Int. Cl. F03D 3/06

(52) U.S. Cl. 416/197 A

(57) ABSTRACT

A vertical axis wind turbine comprising at least two overlapping rotor portions, each having a curved or semi-circular horizontal cross-section, each rotor portion having an outer leading edge that is angled relative to vertical from bottom to top in the direction of rotation of the wind turbine. The magnitude of the angle is in the range of from 5 to 30°. The angled leading edge improves aerodynamic performance of the wind turbine relative to the absence of the angle, particularly for turbines with three or more rotor portions.

### CROSS REFERENCE TO RELATED APPLICATIONS

This application claims the benefit of U.S. Patent Application 61/053,018, filed May 14, 2008, which is incorporated herein by reference.

### FIELD OF THE INVENTION

The invention relates to improvements in vertical axis wind turbines. More particularly, the invention relates to aerodynamic improvements in turbines comprising at least two rotor portions, for example semi-cylindrical rotor portions, such as in Savonius-type turbines.

### BACKGROUND OF THE INVENTION

Vertical axis wind turbines, or VAWT's, are known for use in power generation and water pumping applications. Savonius wind turbines are a type of vertical-axis wind turbine, used for converting the power of the wind into torque on a rotating shaft. They were invented by the Finnish engineer Sigurd J Savonius in 1922. Savonius turbines are one of the simplest turbines. Aerodynamically, they are drag-type devices. A simple Savonius turbine can be formed by taking a vertical cross section through a cylinder, then offsetting the two halves of the cylinder laterally from one another and connecting the two halves. Looking down on the turbine from above, it would have a generally “S” shaped cross section, although a small degree of overlap (typically 10-20% of the total diameter) is often provided. Although the Savonius turbine can include more than two of these semi-cylindrical rotor portions, most turbines have a maximum of three rotor portions. Because of the curvature, the scoops experience less drag when moving against the wind than when moving with the wind. The differential drag causes the Savonius turbine to spin. A central vertical shaft is normally provided to transfer the power generated by the turbine to a load. In larger models, a number of S-shaped sections can be stacked on top of one another, with each section being rotated about the central shaft relative to the one below.

Because they are drag-type devices, Savonius turbines extract much less of the wind's power than other similarly-sized lift-type turbines. Reported power coefficients for Savonius turbines vary from about 0.15 to about 0.30. It would therefore be desirable to improve the aerodynamic efficiency of Savonius turbines. Although various attempts have been made to alter the shape of the rotor, reduce drag through use of fairings, or deflect additional wind into the rotor, these approaches all either add cost and complexity to the turbine, impede the omni-directional nature of the turbine, or result in negligible improvement across a range of conditions.

There is therefore a need for efficiency improvements in vertical axis wind turbines.

### SUMMARY OF THE INVENTION

According to the present invention, there is provided a vertical axis wind turbine having at least one turbine section comprising at least two rotor portions, each portion having a bottom, a top, a curved horizontal cross section and an outer leading edge between the bottom and the top, the leading edge being angled relative to vertical from bottom to top in a direction of rotation of the turbine by from 5 to 30 degrees.

It has surprisingly been found that by introducing a downwind angle from vertical to the leading edge of the turbine, an improvement in power output can be obtained, which translates to an improvement in operating efficiency for the turbine. This finding is particularly unexpected, given that drag based wind turbines of the Savonius type have been studied for many years and are commonly understood to have poor efficiency relative to their lift based counterparts. However, since these types of turbines are relatively inexpensive to build and maintain, the improvement is expected to have great practical significance, particularly in less developed and/or poorly serviced parts of the world.

The turbine has a centrally located vertical axis and may further comprise a central vertical shaft. A central shaft is not required to extract power from the turbine, as the structure of the turbine can be made quite rigid when the sections are assembled so that power can be extracted from the bottom of the turbine, for example using a large diameter ring gear. The direction of rotation of the turbine is with the prevailing wind direction. The rotor portions may be laterally offset from one another along a radius of the turbine. The rotor portions may overlap along the radius of the turbine at a center of the turbine. The direction of rotation may be towards a concave side of the curved horizontal cross section. The concave side of each complementary rotor portion may be oppositely oriented. The curved horizontal cross-section may be semi-circular or semi-ellipsoidal.

The turbine may comprise a plurality of sections, each section comprising at least two rotor portions. The turbine may comprise a single section or two or more vertically stacked sections. The turbine may comprise at least two sections. The turbine may comprise at least three sections. The turbine may comprise at least four sections. The turbine may comprise at least five sections. The turbine may comprise at least six sections. Each section may be rotated about a central vertical axis by 90 degrees divided by the total number of sections minus 1 relative to an adjacent section. Each section may comprise two rotor portions. Each section may comprise three rotor portions.

The leading edge may be angled by from about 5 to about 30 degrees. The leading edge may be angled by from about 6 to about 29 degrees. The leading edge may be angled by from about 6 to about 28 degrees. The leading edge may be angled by from about 7 to about 27 degrees. The leading edge may be angled by from about 8 to about 26 degrees. The leading edge may be angled by from about 9 to about 25 degrees. The leading edge may be angled by from about 10 to about 25 degrees. The leading edge may be angled by from about 11 to about 24 degrees. The leading edge may be angled by from about 12 to about 23 degrees. The leading edge may be angled by from about 13 to about 22 degrees. The leading edge may be angled by from about 14 to about 21 degrees. The leading edge may be angled by from about 15 to about 20 degrees.

The leading edge may be angled by from about 9 to about 21 degrees. The leading edge may be angled by from about 10 to about 20 degrees. The leading edge may be angled by from about 12 to about 19 degrees. The leading edge may be angled by from about 14 to about 18 degrees. The leading edge may be angled by from about 16 to about 17 degrees.

### BRIEF DESCRIPTION OF THE DRAWINGS

Having summarized the invention, preferred embodiments thereof will now be described with reference to the accompanying figures, in which:

FIG. 1 is a perspective view of an embodiment of a completely assembled vertical axis wind turbine according to the present invention, comprising five vertically stacked sections and a frame;

FIG. 2a is a side view of a turbine similar to that of FIG. 1, but without the frame and comprising four vertically stacked sections, each section comprising two rotor portions, each section rotated relative to an adjacent section about a central vertical axis of the wind turbine;

FIG. 2b is a perspective view of the turbine of FIG. 2a;

FIG. 3a is a top view of a turbine section comprising two rotor portions;

FIG. 3b is a front view of the turbine section of FIG. 3a;

FIG. 3c is another top view of the turbine section of FIG. 3a;

FIG. 3d is a side view of the turbine section of FIG. 3c;

FIG. 4a is a top view of a turbine section comprising three rotor portions;

FIG. 4b is a front view of the turbine section of FIG. 4a;

FIG. 4c is a side view of an embodiment of a wind turbine comprising five vertically stacked turbine sections according to FIG. 4b, each section identically stacked relative to the adjacent section (i.e. not rotated from the one below it about a central vertical axis of the wind turbine);

FIG. 4d is a schematic top view of a turbine section comprising three rotor portions, illustrating the relationship between various geometric variables;

FIG. 5a is a side view of an embodiment of a wind turbine comprising five vertically stacked sections, each section comprising two rotor portions, each section rotated relative to an adjacent section about a central vertical axis of the wind turbine, with a disc between the sections;

FIG. 5b is a top view of the embodiment of FIG. 5a, with the disc between sections omitted for clarity;

FIG. 6a is a side view of a wind tunnel used for performance testing of wind turbine models;

FIG. 6b is an end view of the wind tunnel of FIG. 6a;

FIG. 7 is a normalized power curve for a number of models comprising two rotor portions;

FIG. 8 is a normalized power curve for a number of models comprising three rotor portions;

FIG. 9a is a top view of a turbine section comprising three rotor portions with a disc at the top and/or bottom thereof; and,

FIG. 9b is a side view of an embodiment of a wind turbine comprising five vertically stacked turbine sections according to FIG. 9a, each section identically stacked relative to the adjacent section (i.e. not rotated from the one below it about a central vertical axis of the wind turbine) and having a disc between adjacent sections.

### DETAILED DESCRIPTION

Throughout the Detailed Description, like features will be described by like reference numerals. Though all reference numerals used in describing a particular drawing may not be shown on that actual drawing, other drawings showing and describing that particular reference numeral may be referred to.

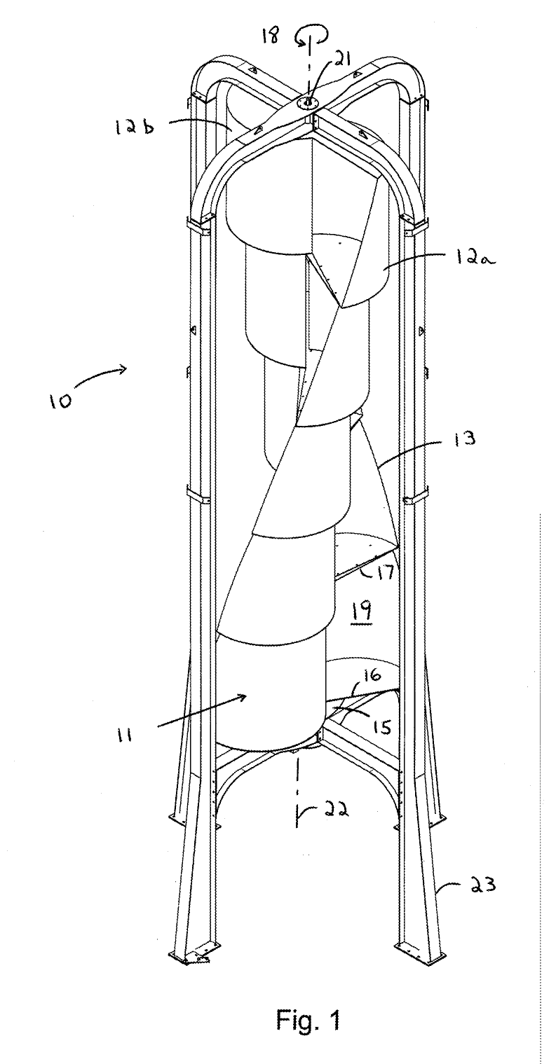

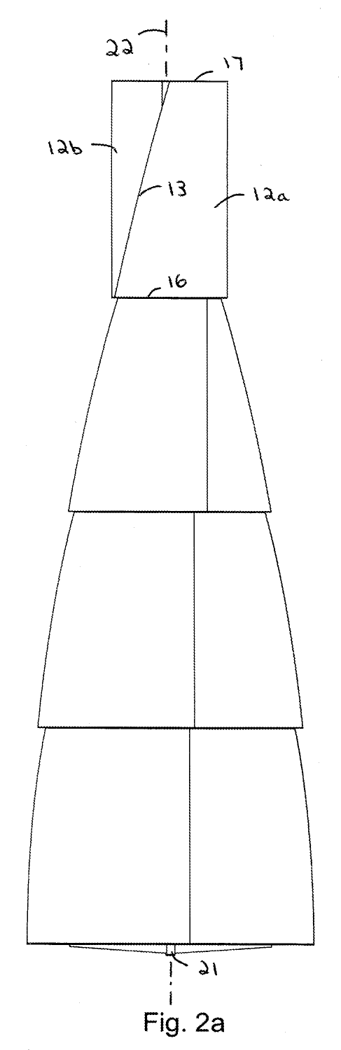

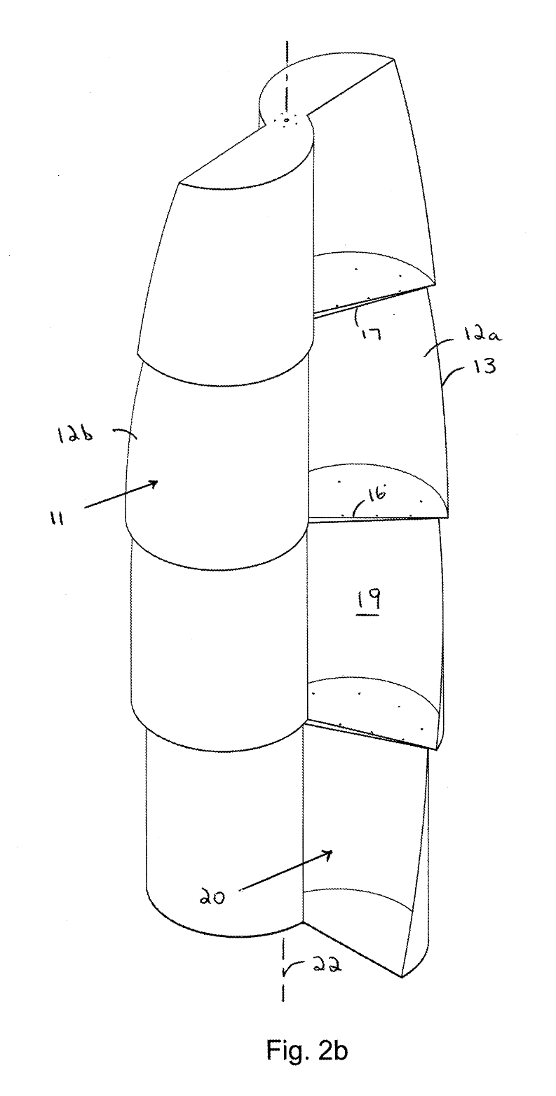

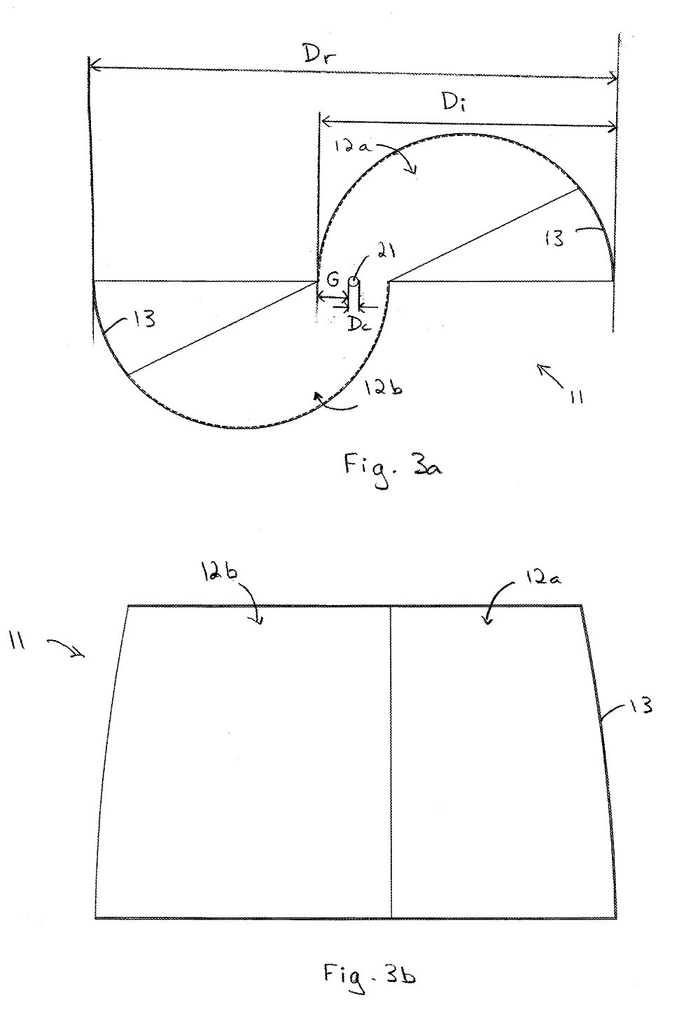

Referring to FIGS. 1 and 2a-b, an embodiment of a vertical axis wind turbine 10 according to the present invention comprises four turbine sections 11, each section comprising two rotor portions 12a, 12b. Each rotor portion 12a, 12b has a curved horizontal cross-section (a substantially semi-circular cross-section) and an outer leading edge 13, proximal an outer circumference of the turbine 10 and facing into the prevailing wind direction, shown by arrow 20. The outer circumference of the turbine is defined by a circle passing through the bottom of each leading edge 13. A bottom disk 15 may optionally be provided and may have a diameter as shown or a greater diameter. The leading edge 13 of each rotor portion 12a, 12b is angled relative to vertical from bottom 16 to top 17 toward a direction of rotation of the turbine, generally denoted as 18. The direction of rotation 18 is toward a concave side 19 of the rotor portion 12a and is about a centrally located shaft 21 having a vertical axis of rotation 22 passing therethrough. The rotation 18 is with the prevailing wind direction 20.

The angle of the leading edge 13 shown in FIGS. 1 and 2a-2b is about 15°. Although the leading edge 13 appears curved when shown in side view (FIG. 2a), the angle on the leading edge is constant from bottom to top. Of course, in other embodiments, a non-constant leading edge 13 from bottom to top could be used and still fall within the scope of the invention. A compound leading edge 13 may comprise multiple angles, provided that one of the angles is within the inventive range disclosed herein. With a constant angle on the leading edge 13, the angle of the leading edge relative to vertical can be measured at a tangent to any point on the leading edge. For simplicity, it is preferred to measure the angle of the leading edge 13 relative to vertical at the bottom of the leading edge, where it intercepts the bottom 16.

FIG. 1 shows the turbine 10 within a frame 23. The central shaft 21 is secured within thrust bearings at the top and bottom of the frame 23 to permit free rotation of the turbine 10. The frame 23 is but one embodiment of a frame or mounting structure suitable for holding the turbine 10 in position. Persons skilled in the art can readily envision alternative mounting structures. If assembled with sufficient rigidity, it is possible to eliminate the frame 23 altogether and derive power from the turbine 10 directly, for example using a ring gear or similar arrangement mounted to the underside of the disk 15.

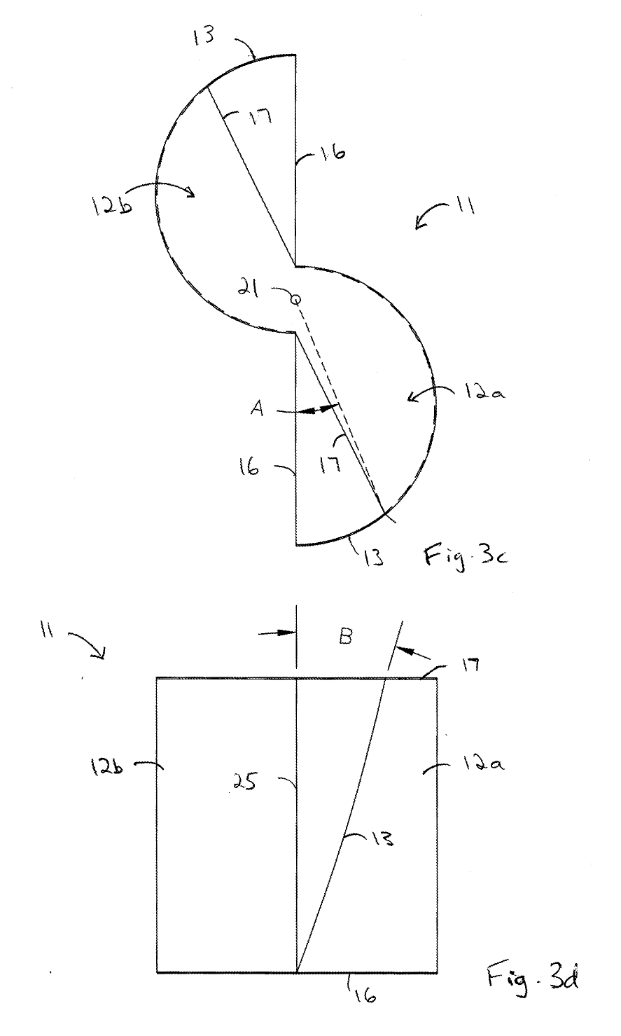

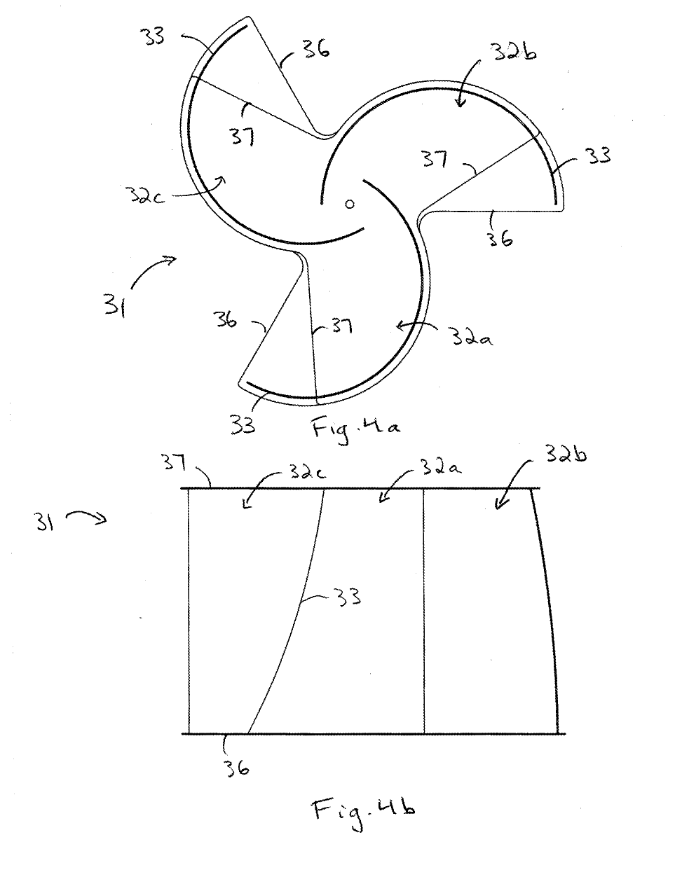

Referring now to FIGS. 3a and 3b, a single section 11 of the turbine 10 is shown. The overall diameter of the turbine 10 at the base of each section 11 is equal to the sum of the diameters of the two rotor portions 12a, 12b, minus the overlap between rotor portions. The overall diameter Dr is shown and relates to the sum of the diameter Di of each rotor portion 12a, 12b minus the overlap distance 2G+Dc, wherein G is the distance between the inside edge of a rotor portion 12a or 12b and the central shaft 21 and Dc is the diameter of the central shaft. In preferred embodiments, the overlap is 10-15% of the overall diameter Dr.

Referring to FIGS. 3c and 3d, the angle of the leading edge 13 can be determined in two ways. One way of determining the angle of the leading edge 13 is shown in the top view (FIG. 3c), where the angle A represents the angle between the bottom 16 and a chord of the rotor portion 12a extending from the center shaft 21 to the intersection of the top 17 with the leading edge 13. Another method is shown in side view (FIG. 3d), wherein a vertical line 25, in this view provided by the inside edge of the complementary rotor portion 12b, intercepts the leading edge at the bottom 16 and the angle B is determined between the vertical line 25 and a tangent at that intercept. This is the most direct way of measuring the angle of the leading edge 13 relative to vertical. Although the angle B can be determined by taking a tangent at any point along the leading edge, in side view the only orthogonal representation of the angle is at the bottom 16. Persons skilled in the art will of course understand that there is a mathematical relationship between the angles A and B relating to the diameter Di of each rotor portion 12a, 12b, the overlap G, central shaft diameter Dc and the height of each rotor portion. It is therefore possible to describe the angle of the leading edge 13 using either method. However, for simplicity, the angle B provides the most direct representation of the angle of the leading edge as described and claimed herein.

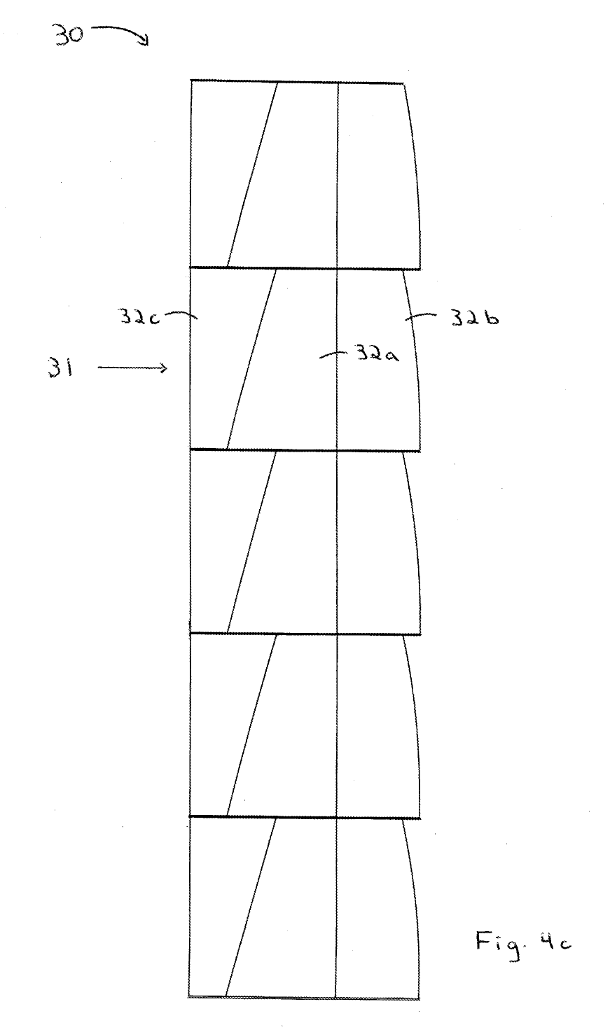

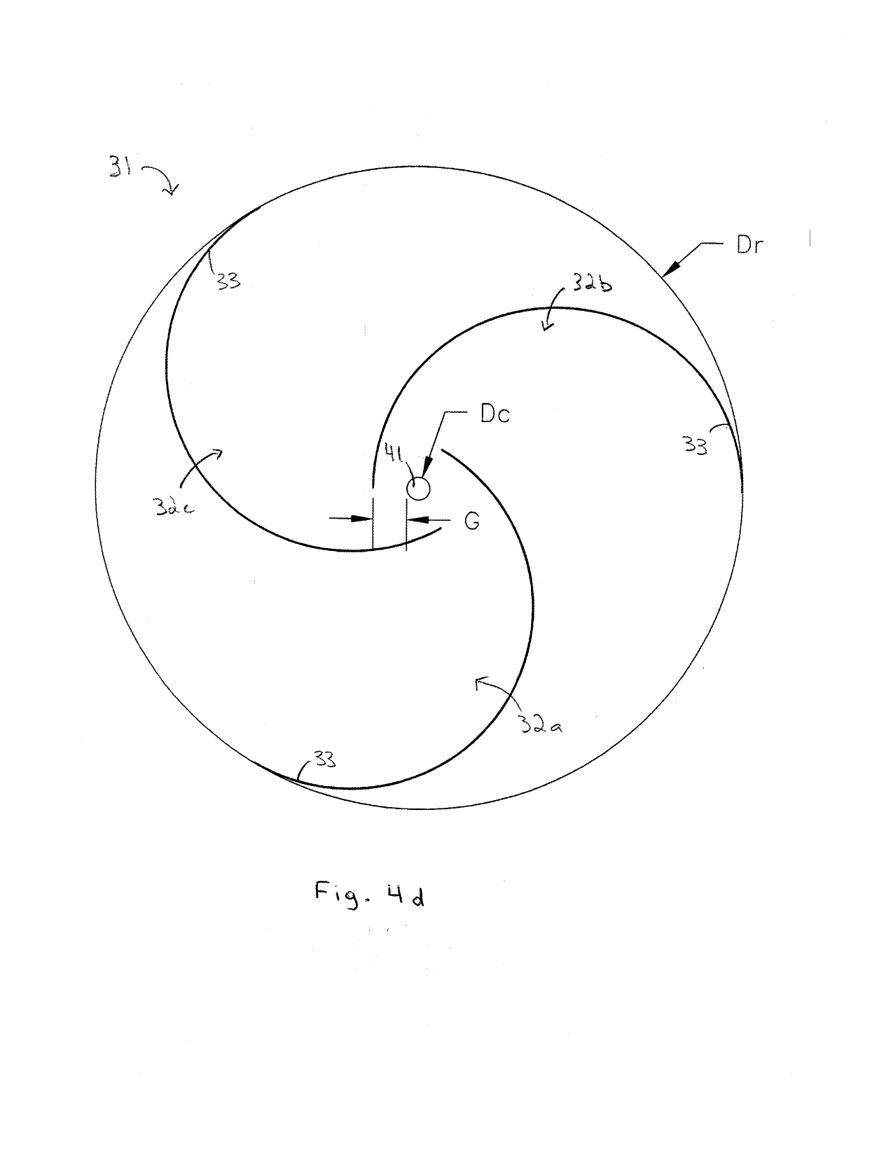

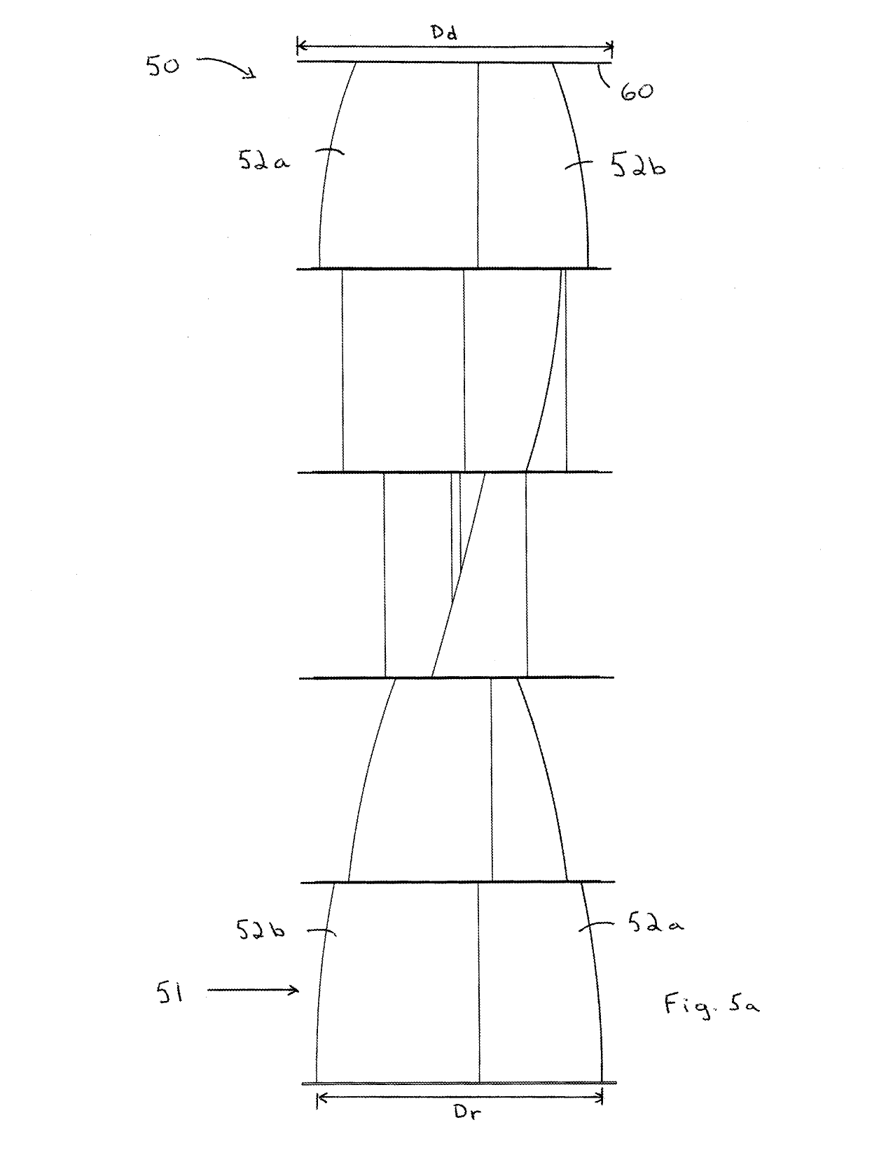

Referring to FIGS. 4a and 4b, a turbine section 31 is shown comprising three rotor portions 32a, 32b, 32c. Each rotor portion has a curved horizontal cross-section (semi-circular) and has an outer leading edge 33 that is angled relative to vertical from a bottom 36 to a top 37 of the rotor portion 32a, 32b, 32c. Although the bottom 36 and top 37 are shown to extend slightly beyond the outer circumference of the rotor portions 32a, 32b, 32c, this is a matter of manufacturing convenience and need not necessarily be so for performance purposes. The turbine section 31 is in most other respects similar to the two rotor turbine section 11 previously described. In particular, the method of determining the angle of the leading edge 33 with respect to vertical is as described above with reference to angles A and B on FIGS. 3c and 3d.

Referring to FIG. 4d, the geometric relationships between the rotor sections 32a, 32b, 32c will now be more fully described. The overall diameter of the turbine section 31 is described by Dr, which is the diameter of a circle passing through the bottom of the leading edge 33 of each rotor portion 32a, 32b, 32c. The diameter of the central shaft 41 is denoted by Dc. The distance G relates to the distance between the inside edge of a rotor portion 32a, 32b or 32c and the shaft Dc. Using these definitions, preferred values for the geometric variables are as follows: Dc from 0.02 to 0.05 of Dr, G from 0.04 to 0.08 of Dr and the height of each section 31 is from 0.60 to 0.70 of Dr.

Referring to FIG. 4c, a turbine 30 according to the invention can be assembled from four or five turbine sections 31. The turbine sections 31 are vertically stacked upon adjacent sections and preferably secured thereto by suitable means. An alternative or additional approach is to secure the sections 31 to the central shaft (not shown in this view). The sections 31 are shown to be identically stacked; this means that the orientation of a given section 31, relative to the incoming wind direction, is identical to the orientation of the adjacent sections. In this manner, all of the rotor portions 32a, 32b, 32c of adjacent sections 31 are vertically aligned with one another. It has been found that, in wind turbine embodiments 30 comprising three rotor portions 32a, 32b, 32c, the turbine is sufficiently self-starting regardless of incident wind conditions that no “twist” (i.e. rotation of adjacent sections about a central axis of rotation or central shaft) is required. This can simplify design and construction of the turbine. However, a twisted configuration similar to that shown for the two rotor portion embodiments of FIGS. 1, 2a, 2b could also be adopted for the three rotor portion embodiment described here.

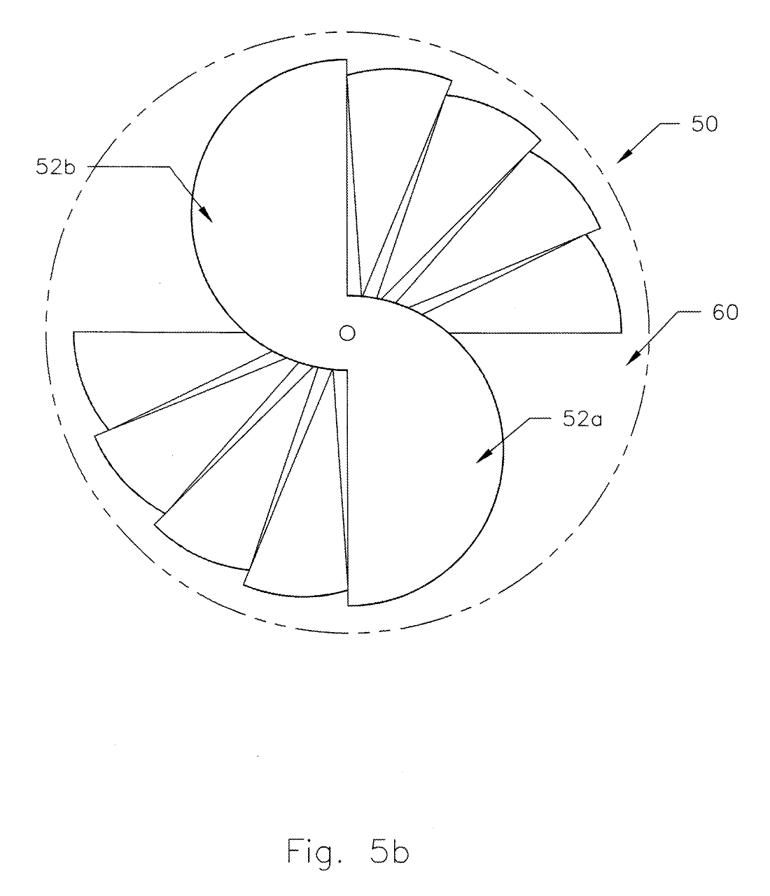

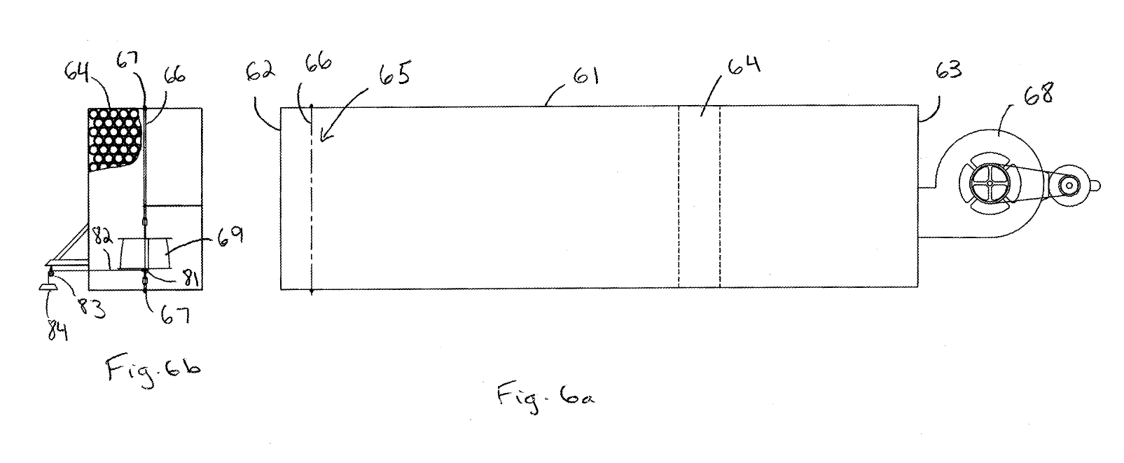

Referring to FIGS. 5a and 5b, a turbine 50 according to the invention comprising five vertically stacked sections 51 having two rotor portions 52a, 52b for each section is shown in side view. The turbine comprises a disk 60 extending outwardly past the overall diameter (Dr, not shown) of the wind turbine 50 between each of the sections 51 and also at the top of the top section and the bottom of the bottom section. An alternative way of providing this configuration is to provide each section 51 with a top and bottom disk 60 and allowing the disks of adjacent sections to abut one another. The disk 60 has a diameter Dd that is preferably about 10% larger in diameter than Dr. As can be seen best in FIG. 5b, the turbine 50 utilizes a “twisted” configuration wherein adjacent sections are successively rotated about a central axis (not shown) in order to provide easier starting of the turbine regardless of incident wind angle. The disk 60 is hidden in FIG. 5b so as not to obscure other relevant features of the turbine 50.

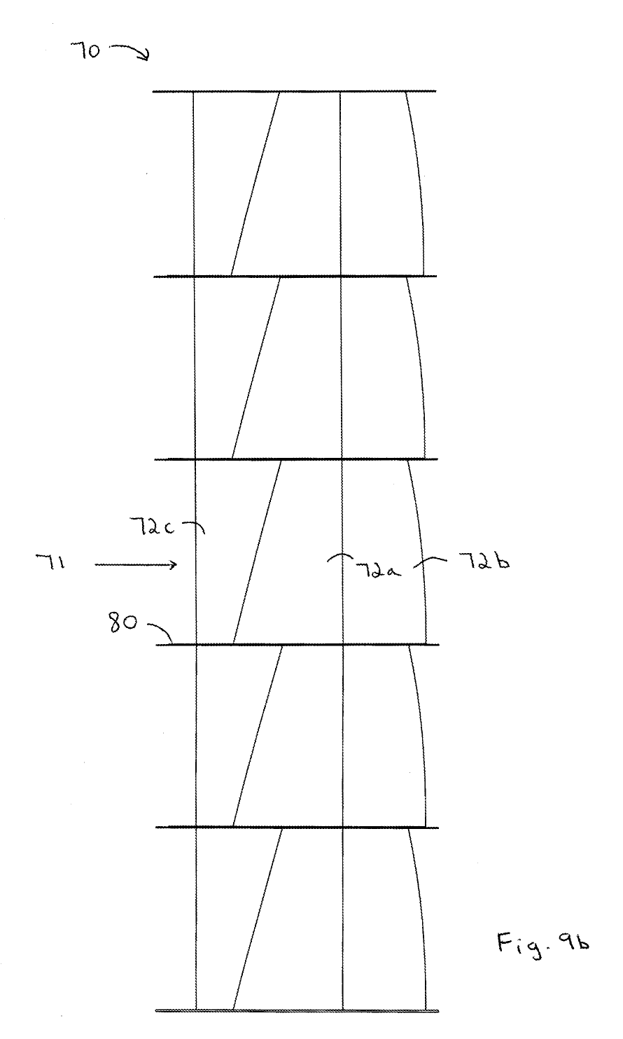

Referring to FIGS. 9a and 9b, a turbine 70 is shown comprising five stacked sections 71, each section comprising three rotor portions 72a, 72b, 72c. The turbine comprises a disk 80 extending outwardly past the overall diameter Dr of the wind turbine 70 between each of the sections 71 and also at the top of the top section and the bottom of the bottom section. An alternative way of providing this configuration is to provide each section 71 with a top and bottom disk 80 and allowing the disks of adjacent sections to abut one another. The disk 80 has a diameter Dd that is preferably about 10% larger in diameter than Dr. The turbine 70 utilizes an identically stacked configuration wherein the rotor portions 72a, 72b, 72c of adjacent sections are vertically aligned with one another. This has been shown to provide sufficiently easy starting, regardless of wind direction, to allow the “twisted” configuration not to be used. However, it is equally evident that a twisted configuration, wherein adjacent sections are successively rotated about a central axis (not shown) could be adopted without departing from the invention.

### EXAMPLES

Wind tunnel testing of scale models was performed in a double open ended flow through wind tunnel. The tunnel will be described with reference to FIGS. 6a and 6b. The main body 61 of the wind tunnel was constructed of sheet metal and had an overall length of 168″, inside height of 47.5″ and inside width of 30″. The exit end 62 of the wind tunnel was the full size of the main body. At the inlet, or blower end 63 of the tunnel, a portion of the cross section of the tunnel was occupied by the blower exit opening, which had a height of 13″, a width of 24″ and was centered with the bottom of its opening 13″ above the floor of the main body 61 of the tunnel. The blower 68 was manufactured by Gould and had a ½ Hp, 120 Vac motor. By providing an opening at the blower end, additional room air was sucked into the tunnel, without having to flow through the blower. This significantly increased air flow through the tunnel, generally averaging 5.0-5.3 m/s near the top of the tunnel. A flow distributor and straightener 64 was provided 52″ from the blower end 63 of the tunnel in order to aid in providing well distributed smooth flow. The distributor and straightener 64 filled the entire tunnel cross-section and was comprised of horizontally oriented paper cores, each 11″ long with a 2¼″ I.D. opening. These provided an air flow in the testing area 65 that was about 15% greater than at the wall, or about 6.0 m/s.

The testing area 65 was located 150″ into the tunnel from the blower end 63. Models 69 were mounted on a shaft 66 comprising a length of ¼″-20 threaded rod that was secured vertically within ball bearings 67 mounted to the top and bottom of the tunnel. A 1½″ diameter steel prony brake pulley 81 was secured to the rod about 4″ above the tunnel floor. A braided polypropylene cord 82 was half-wrapped about the circumference of the pulley, with one end secured to the interior wall of the tunnel and the other end passing through the tunnel wall and over a second 1½″ diameter idler pulley 83. A weight receptacle 84 was hung from the free end of the cord to provide a variable tension on the cord according to the amount of weight in the receptacle. This prony brake system allowed a measurable and controlled amount of resistance to be applied to the shaft in order to allow relative torque measurements to be made for the models.

Air temperature was not controlled, but was in the range of 5 to 15° C. throughout the testing. Although it was noticed that warmer temperatures caused a decline in performance, all comparison tests were conducted while room temperature changed very little, about +/−2° C. A non-contact laser hand held sensor was used to measure RPM by directing it toward a small piece of reflective tape attached to the exterior of the model being tested.

Models were made from a stiff, model building cardboard. This allowed the leading edge angle of the model to be changed, without affecting any other parameters. For relative comparisons, a single section model was tested. The models had a height of 7.83″, overall diameter (as a circle plotted through the bottom of the leading edge of each rotor portion) of 13″ and an overlap between rotor portions of 0.9″. In certain embodiments, discs were added to the top and bottom of the models that were 14.3″ in diameter, or 10% greater in diameter than the overall diameter as described above. These dimensions were derived to provide a 1/10th scale version of an otherwise identical full size wind turbine.

By combining the brake torque and rpm measurements, a relative power output for each model could be calculated. This allowed comparison between models in order to determine the impact of changes to the leading edge angle and/or model configuration on power output at constant wind tunnel conditions. The relative power was calculated according to the following procedure.

Power is defined by,

P (W)=Force (N)*Distance (m)/Time (s); (1)

where the product of Force and Distance is otherwise known as Torque. For a prony brake, Force is the pulley friction defined by:

F (N)=T₂ (N)−T₁ (N); (2)

where T₂ is the tension measured on one side of the pulley and T₁ is the tension measured on the opposite side of the pulley. For a rotating pulley, T₂ is defined by a relationship with T₁ where:

T₂=T₁e^{(μkβ)}; (3)

where μₖ is the coefficient of kinetic friction between the cord and the pulley and β is the angle between the cord and pulley, in radians. For a cord in complete semi-circular contact with the pulley, the angle between the two ends of the cord at their tangent points with the pulley is 180°, or π in radians.

Substituting equation (3) into equation (2) and π for β yields:

F=T₁e^{(μkπ)}−T₁

F=T₁[e^{(μkπ)}−1]. (4)

The distance traveled by the pulley in a unit of time is the circumference of the pulley times the number of revolutions per unit of time:

Distance (m)/Time (s)=πdₚ*rev/s; (5)

where dₚ is the diameter of the pulley in meters. Substituting equations (4) and (5) into equation (1) yields:

P (W)=T₁[e^{(μkπ)}−1]*πdₚ*rev/s. (6)

T₁ is defined by the force due to gravity acting on the weighted receptacle, which is:

T₁=mass (kg)*acceleration due to gravity (m/s²)

T₁=mass (kg)*9.8 (m/s²) (7)

Substituting equation (7) into equation (6) and re-arranging to isolate the unknowns yields the normalized power relationship:

P/[[e^{(μkπ)}−1]*πdₚ]=9.8 (m/s²)*mass (kg)*rev/s. (8)

The units on equation (8) simplify to W/m of pulley diameter. For a constant wind tunnel test setup, where the prony brake pulley and cord remain unchanged, the denominator of the left hand side of equation (8) remains constant. Hence, any observed changes in performance are attributable to the numerator of equation (8), meaning that relative power outputs can be reliably compared between models.

### Example 1

### Two Rotor Portion Models

In the wind tunnel, single section two rotor portion models were prepared as shown in FIGS. 3c and 3d. With reference to those figures, the leading edge angle B and corresponding top edge radial angle A that were tested in a first series of experiments are as shown in Table 1, below.

TABLE 1
Angles of Tested Models for First Series of Experiments

| Experiment | Angle A | Angle B |
|---|---|---|
| Control 1 | 0° | 0° |
| Exp. 1 | 12.0° | 9.7° |
| Exp. 2 | 22.5° | 16.6° |
| Exp. 3 | 30.0° | 20.5° |

In a second series of experiments, single section two rotor portion models according to FIGS. 3c and 3d were made, but with a circular disc added to the top and bottom of each model that was 10% larger in diameter than the distance from the leading edge of one rotor portion to the leading edge of the opposite rotor portion at the bottom of the model (in other words, the sum of the diameters of the two rotor portions, less the center overlap). These experiments are presented in Table 2, below:

TABLE 2
Angles of Tested Models for Second Series of Experiments

| Experiment | Angle A | Angle B |
|---|---|---|
| Control 2 | 0° | 0° |
| Exp. 4 | 22.5° | 16.6° |

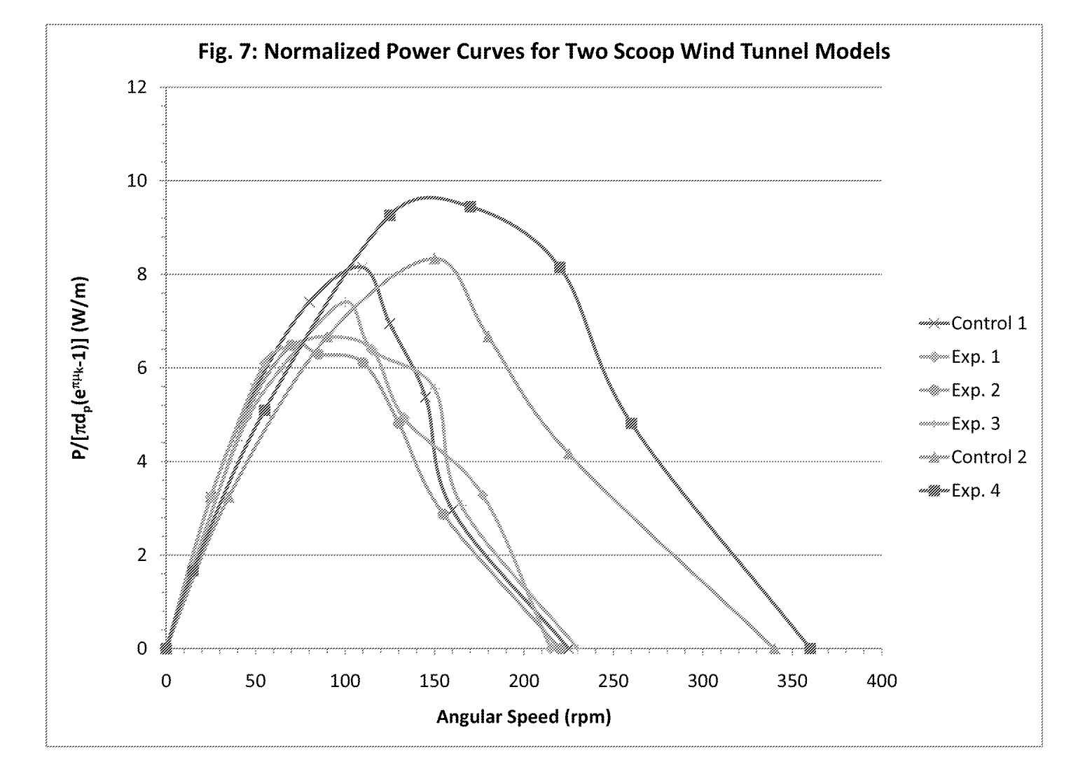

The normalized power curves for these two series of experiments are presented in FIG. 7. In reviewing these figures, it can be seen that, for the first series of experiments comprising two rotor portion models without the disc, providing an angle to the leading edge decreased performance as compared with Control 1. When a disc was added to the top and bottom, no change in maximum power was observed for Control 2 relative to Control 1. However, by providing an angle to the leading edge, a further power increase of 14.5% was obtained for Exp. 4 relative to Control 2. This significant increase in power is surprising, particularly in view of the results obtained from the first series of experiments. A further observation is that the breadth of the power curve increased significantly for Exp. 4 relative to the controls, indicating that the operating envelope of the turbine increased by virtue of providing an angle to the leading edge. This is also an important benefit, as it allows the turbine to be more easily controlled over a range of operating conditions.

### Example 2

### Three Rotor Portion Models

In a fashion similar to that described for Example 1, a third series of experiments was performed with a turbine section comprising three rotor portions, rather than two. The leading edge was measured in the same manner as for Example 1, with the angles A and B being determined with reference to a three rotor portion section rather than a two rotor portion section. The model conditions studied are outlined in Table 3.

TABLE 3
Angles of Tested Models for Third Series of Experiments

| Experiment | Angle A | Angle B |
|---|---|---|
| Control 3 | 0° | 0° |
| Exp. 5 | 22.5° | 16.6° |

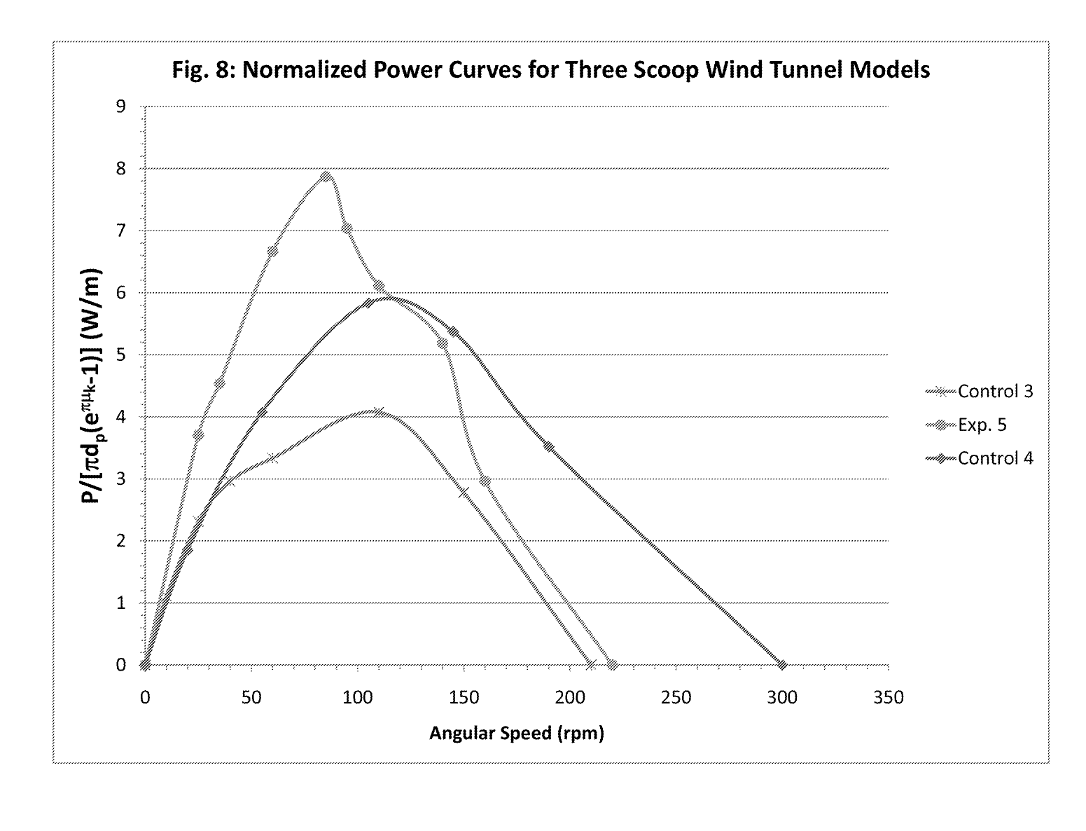

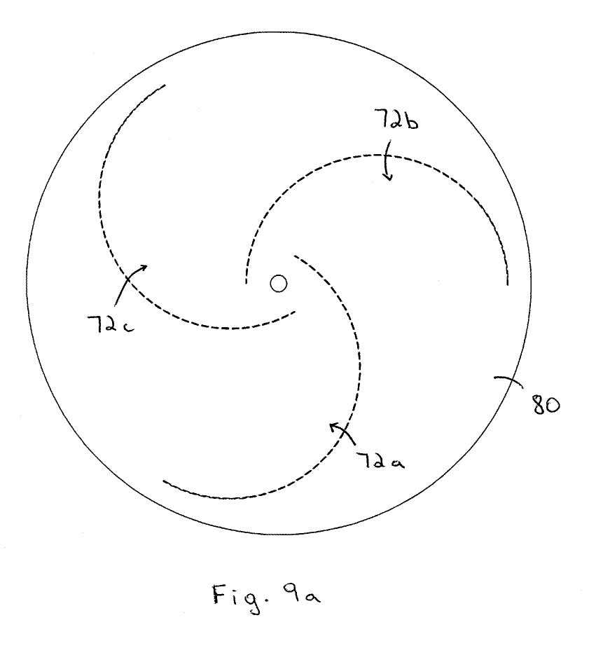

The conditions described in Table 3 are without the top and bottom disc being provided. However, a fourth control was studied, designated Control 4, that was based on Control 3 (three rotor portions, no angle to the leading edge), but with the top and bottom disc as described above with reference to Table 2. The normalized power curves obtained from this third series of wind tunnel experiments, with the three rotor portion models, are provided in FIG. 8.

Referring to FIG. 8, it can be seen by comparing Exp. 5 with Control 4 that there is a significant improvement in peak power of 93% provided by the addition of the angled leading edge. This result is surprising due to its magnitude, but also in view of the fact that the opposite was true with the two rotor portion models. In comparing Control 4 and Control 5, there is a significant improvement provided in peak power through the addition of the disc to top and bottom. The same widening in breadth of the power curve as previously observed in Example 1 was also seen in this series of experiments. Although no experiment was performed with the angled leading edge and the disc on top and bottom for the three scoop rotor, based on the observation in Example 1 that the addition of the disc improved performance even further when the angled leading edge was present, it is expected that the same would hold true with the three rotor portion models. Accordingly, it is predicted that the three rotor portion models with a disc on top and bottom would have performance equal to or greater than Exp. 5. A further observation that was made during these tests, although not documented quantitatively, was that the models with three rotor portions were easier to start than those with two rotor portions; in other words, the three rotor portion models were relatively insensitive to incident wind direction as compared with the two rotor portion models. This is expected to make the three rotor portion models easier to operate in real world conditions, with fewer tendencies towards stalling when the wind comes from certain directions.

Having described preferred embodiments of the invention, it will be understood by persons skilled in the art that certain variants and equivalents can be substituted for elements described herein without departing from the way in which the invention works. It is intended by the inventor that all sub-combinations of features described herein be included in the scope of the claimed invention, even if not explicitly claimed.

1. A vertical axis wind turbine having at least one turbine section comprising at least two rotor portions, each portion having a bottom, a top, a curved horizontal cross section and an outer leading edge between the bottom and the top, the leading edge being angled relative to vertical from bottom to top in a direction of rotation of the turbine by from 5 to 30 degrees.

2. The turbine according to claim 1, wherein the wind turbine has an overall diameter defined by a circle plotted through the bottom of the leading edge of each rotor portion, the turbine further comprising a disc on the top and bottom having a diameter larger than the overall diameter.

3. The turbine according to claim 2, wherein the disc has a diameter at least 10% larger than the overall diameter.

4. The turbine according to claim 2, wherein the turbine comprises two rotor portions.

5. The turbine according to claim 2, wherein the turbine comprises three rotor portions.

6. The turbine according to claim 1, wherein the turbine comprises a plurality of vertically stacked rotor sections.

7. The turbine according to claim 6, wherein the turbine comprises four rotor sections.

8. The turbine according to claim 6, wherein the turbine comprises five rotor sections.

9. The turbine according to claim 6, wherein each rotor section is identically stacked upon relative to an adjacent section.

10. The turbine according to claim 6, wherein each rotor section is rotated about a central vertical axis relative to an adjacent section.

11. The turbine according to claim 10, wherein each rotor section is rotated about the central vertical axis by 90 degrees divided by the total number of sections minus 1 relative to an adjacent section.

12. The turbine according to claim 6, wherein the wind turbine has an overall diameter defined by a circle plotted through the bottom of the leading edge of each rotor portion, the turbine further comprising a disc on the top and bottom of each rotor section having a diameter larger than the overall diameter.

13. The turbine according to claim 12, wherein the disc has a diameter at least 10% larger than the overall diameter.

14. The turbine according to claim 12, wherein the turbine comprises two rotor portions.

15. The turbine according to claim 12, wherein the turbine comprises three rotor portions.

16. The turbine according to claim 1, wherein the turbine comprises three rotor portions.

17. The turbine according to claim 1, wherein the curved horizontal cross-section is semi-circular or semi-ellipsoidal.

18. The turbine according to claim 1, wherein the leading edge is angled by from about 9 to about 21 degrees.

19. The turbine according to claim 1, wherein the leading edge is angled by from about 10 to about 20 degrees.

20. The turbine according to claim 1, wherein the turbine comprises a central vertical shaft.
